(19) United States
(12) Patent Application Publication
(10) Pub. No.: US 2004/0025322 A1
(43) Pub. Date: Feb. 12, 2004

(54) Waffle wafer chuck apparatus and method

(76) Inventor: Michael Binnard, Belmont, CA (US)

Correspondence Address: Law Offfice Of Leland Wiesner, 1144 Fife Ave., Palo Alto, CA, 94301, US

(21) Appl. No.: 10/212,886

(22) Filed: Aug. 6, 2002

(51) Int. Cl. H01S 4/00

(52) U.S. Cl. 29/592.1

(57) ABSTRACT

An apparatus for holding a substrate includes slots to increase accuracy required for precision manufacturing. The holding apparatus has a flat upper surface configured to attach to the substrate, a lower surface parallel to the upper surface of the holding apparatus having a number of slots extending lengthwise across the lower surface and depth wise towards the upper surface facilitating flexibility in the lower surface. In one implementation, a wafer chuck having slots in its lower surface and supported by a based flexes to accommodate imperfections in the surface of the base. Because of the slots, the lower surface of the wafer chuck flexes without flexing the upper surface of the wafer chuck and the wafer or other substrate mounted on the upper surface of the wafer chuck. This reduces distortion in the wafer during fabrication and facilitates the high degree of accuracy required for precision manufacturing.

### TECHNICAL FIELD

This invention relates to a method and apparatus used in precision manufacturing for reducing distortion of a substrate mounted to a chuck. This is useful in microlithography and manufacture of microelectronic devices used in integrated circuits, displays, thin-film magnetic pickup heads and micromachines.

### BACKGROUND

Microlithographic methods providing greater accuracy at higher resolution are needed as the density and miniaturization of microelectronic devices continues to increase. Currently, most micro lithography is performed using, as an energy beam, a light beam (typically deep UV light) produced by a high˜pressure mercury lamp or excimer laser, for example. These micro lithography apparatus are termed “optical” microlithography apparatus. Emerging microlithographic technologies include charged-particle-beam (“CPB”; e.g., electron-beam) micro lithography and “soft-X-ray” (or “extreme UV”) microlithography. Because many contemporary micro lithography machines operate according to the well-known “step-and-repeat” exposure scheme, they are often referred to generally as “steppers.”

Micro lithographic technologies generally involve pattern transfer to a suitable substrate, which can be, for example, a semiconductor wafer (e.g., silicon wafer), glass plate, or the like. So as to be imprintable with the pattern, the substrate typically is coated with a “resist” that is sensitive to exposure, in an image-forming by the energy beam in a manner analogous to a photographic exposure. Hence, a substrate prepared for microlithographic exposure is termed a “sensitive” substrate.

For micro lithographic exposure, the substrate (also termed herein a “wafer”) typically is mounted on a substrate stage (also called a “wafer stage”). The wafer stage is a complex and usually quite massive device that not only holds the wafer for exposure (with the resist facing in the upstream direction) but also provides for controlled movement of the wafer in the X-and Y -directions (and sometimes the Z-direction) as required for exposure and for alignment purposes. In most microlithography apparatus, a number of devices are mounted to and supported by the wafer stage. These devices include a “wafer table” and a “wafer chuck” attached to the wafer table. The wafer table can be used to perform fine positional adjustment of the wafer relative to the wafer stage, and often is configured to perform limited tilting of the wafer chuck (holding the wafer) relative to the Z-axis (e.g., optical axis).

The wafer chuck is configured to hold the wafer firmly for exposure and to facilitate presenting a planar sensitive surface of the wafer for exposure. The wafer usually is held to the surface of the wafer chuck by vacuum, although other techniques such as electrostatic attraction also are employed under certain conditions. The wafer chuck also facilitates the conduction of heat away from the wafer that otherwise may accumulate in the wafer during exposure.

Monitoring of the position of the wafer in the X, Y, and Z-directions must be performed with high accuracy to obtain the desired accuracy of exposure of the pattern from the reticle to the wafer. The key technology employed for such purposes is interferometry, due to the extremely high accuracy obtainable with this technology. Interferometry usually involves the reflection of light from mirrors, typically located on the wafer table, and the generation of interference fringes that are detected. Changes in the pattern of interference fringes are detected and interpreted as corresponding changes in position of the wafer table (and thus the wafer). To facilitate measurements in both the X- and Y-directions over respective ranges sufficiently broad to encompass the entire wafer, the wafer table typically has mounted thereto an X-direction movable mirror and a Y-direction movable mirror. The X-direction movable mirror usually extends in the Y-direction along a full respective side of the wafer table, and the Y direction movable mirror usually extends in the X-direction along a full respective side of the wafer table.

Despite the extremely high accuracy with which modem micro lithography apparatus are constructed and with which positional measurements can be performed in these apparatus, the measurements still are not perfect and hence are characterized by certain tolerances. With respect to these tolerances, a measurement error caused by the apparatus itself is termed a “tool-induced shift,” or “TIS,” an error attributed to variations in the wafers (or other substrates) is termed a “wafer-induced shift,” or “WIS.” The term “tool” is derived from the common reference to a micro lithography apparatus as a “lithography tool.”

Whenever a wafer is mounted on the wafer chuck, the microlithography apparatus normally executes an alignment routine to determine the precise position and orientation of the wafer before initiating exposure of the wafer. To facilitate the alignment, the wafer table typically includes a “fiducial” (reference) mark. Similarly, the wafer itself typically includes multiple alignment marks imprinted thereon. The microlithography apparatus uses both the fiducial mark on the wafer table and alignment marks on the wafer during the alignment and exposure of the wafer or substrate.

Unfortunately, wafer deformities can make the alignment and exposure of the wafer inaccurate or difficult. Deformities in the wafer alter the expected relationships between the alignment marks on the wafer or substrate and the fiducial mark on the wafer table. While some of the deformities are inherent in the wafer, many are introduced through the wafer chuck and interaction with the supporting structures holding the wafer chuck. For example, an imperfection or deformity in a wafer table below the wafer chuck can cause the wafer chuck to bow and thereby introduce a corresponding deformity in the wafer attached to the wafer chuck.

In some cases, imperfections in the wafer table below the wafer chuck arise during processing due to changes in temperature and physical forces surrounding the wafer. For example, energy used to expose the wafer can cause the wafer and/or wafer table to become distorted as the equipment heats or cools. Consequently, reducing the deformities in a wafer requires precision systems that detect and accommodate imperfections in the equipment that arise both before and during the precision manufacturing process.

### SUMMARY OF THE INVENTION

One aspect of the invention features a slotted holding apparatus for supporting a substrate during precision manufacturing and processing. The holding apparatus has a flat upper surface configured to attach to the substrate, a lower surface parallel to the upper surface of the holding apparatus having a number of slots extending lengthwise across the lower surface and depth wise towards the upper surface facilitating flexibility in the lower surface. In one implementation, a wafer chuck having slots in its lower surface and supported by a base flexes to accommodate imperfections on the surface of the base. Because of the slots, the lower surface of the wafer chuck flexes without significantly distorting the upper surface of the wafer chuck. Consequently, a wafer or other substrate mounted on the upper surface of the wafer chuck suffers less deformation before and during manufacturing and processing. Reducing the potential distortion of a wafer or substrate during fabrication facilitates the high level of accuracy required for precision manufacturing.

Another aspect of the invention includes a precision manufacturing apparatus that uses the holding member with slots to support a substrate during processing. This precision manufacturing apparatus includes an energy emission system, the holding member in line with the energy emission system having a flat upper surface configured to attach to the substrate and a lower surface parallel to the upper surface of the holding member having a number of slots extending lengthwise across the lower surface and depth wise towards the upper surface facilitating flexibility in the lower surface, a substrate table that attaches to the lower surface of the holding member and configured to adjust the tilt of the holding member and facilitate focusing energy from the energy emission system and a stage coupled to the substrate table that facilitates movement of substrate table along one or more axis relative to the energy emission system. This precision manufacturing apparatus can be adapted for use in fabricating semiconductor materials into microelectronic devices.

Yet another aspect of the invention includes a method of manufacturing a holding member with slots used for supporting a substrate in precision manufacturing. This method includes creating a holding member having an upper surface configured to attach to the substrate and a lower surface parallel to the upper surface of the holding member having a number of slots extending lengthwise across the lower surface and depth wise towards the upper surface that facilitates flexibility in the lower surface, filling the slots on the lower surface with a temporary filler material that strengthens the holding member, precision machining the upper surface of the holding member to articulate with the substrate and then removing the temporary material from each slot in the lower surface of the holding member once the precision machining of the upper surface is complete.

Implementations of the invention include one or more of the following features or advantages. A wafer or substrate produced has fewer imperfections because of the flexibility of the lower surface the wafer chuck or holding member. The lower surface of the holding member flexes to accommodate inconsistent supporting surfaces without distorting the wafer or substrate being supported on the upper surface of the holding member. Further, wafer chuck or holding member is compatible with legacy microlithography and other precision manufacturing equipment without significant reengineering requirements.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 illustrates a portion of a microlithography apparatus used to control the movement of a wafer during the precision fabrication process;

FIG. 2A provides a schematic elevation view of a wafer and the support structure below the wafer used in precision manufacturing;

FIG. 2B depicts the juncture between the uneven surface of a wafer table and the wafer chuck in a conventional system used for holding a wafer;

FIG. 3A is a cross-section view depicting the deformation occurring to a wafer attached to a conventional wafer chuck;

FIG. 3B is a cross-section view of a wafer mounted on a slotted wafer chuck designed to reduce wafer deformation;

FIG. 4 provides a perspective view of a wafer chuck with slots configured to hold holding a semiconductor wafer;

FIG. 5 is an elevation view illustrating a microlithographic instrument incorporating a wafer chuck having slots;

FIG. 6 provides the operations used to fabricate a wafer using a waffle wafer chuck designed in accordance with the present invention;

FIG. 7 depicts operations in a flowchart diagram covering the design and delivery of a final product created using a wafer chuck; and

FIG. 8 is flowchart of the operations associated with fabricating semiconductor devices.

### DETAILED DESCRIPTION

A wafer chuck or holding member designed in accordance with the present invention accommodates inconsistencies in the supporting material below the holding member and minimizes the deleterious effect of these inconsistencies on the wafer or substrate. In the context of wafer fabrication, the bottom side of the wafer table can have some unevenness without causing a corresponding degree of deformation to the wafer mounted on the topside of the wafer chuck. Slots placed on the underside of a wafer chuck flex to accommodate the unevenness on an underlying wafer table without causing a significant corresponding flexing of the wafer mounted on the topside of the wafer chuck. Accordingly, this wafer chuck or holding member design facilitates precision manufacturing of a wafer, substrate or object even when the manufacturing equipment used to support the wafer has some unevenness or imperfections.

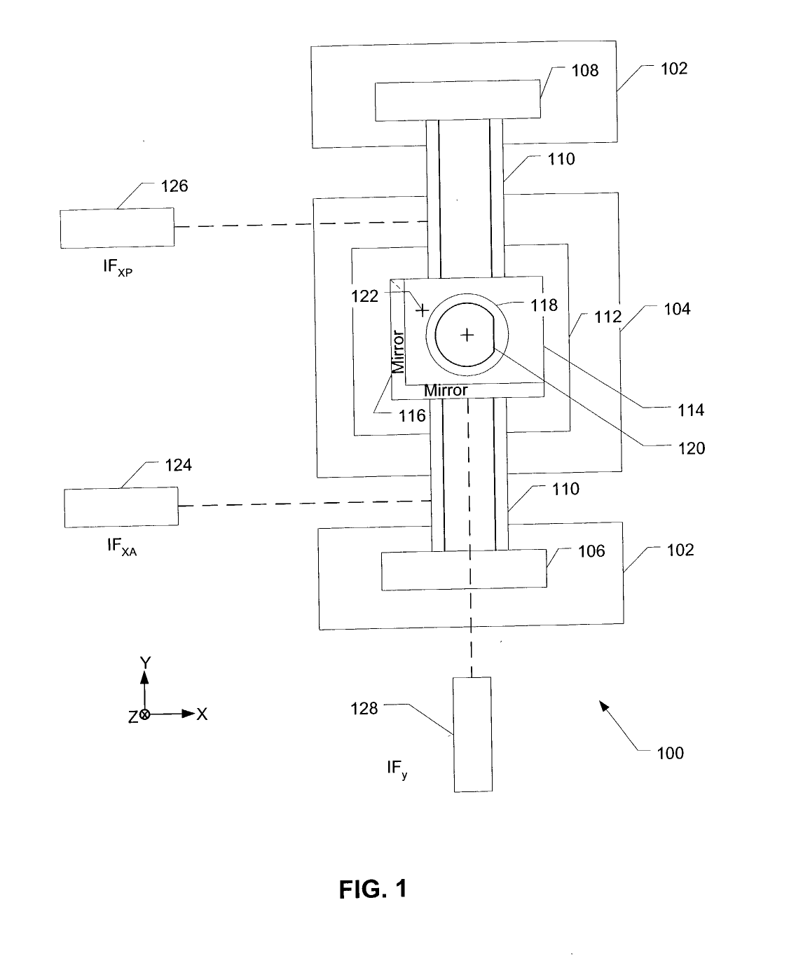

FIG. 1 illustrates a portion of a microlithography apparatus used to hold a wafer during the precision fabrication process. Holding portion 100 in FIG. 1 includes a multipart base with a pair of side bases 102 and a center base 104. X-linear motor 106 and X-linear motor 108 are each supported by one side base from the pair of side bases 102 as depicted. Holding portion 100 further includes a guidebar 110, a wafer stage 112, a wafer table 114, mirrors 116, a wafer chuck 118 and a wafer 120. A fiducial mark (FM) 122 is placed on wafer table 114 to assist in aligning various pieces of hardware before and during the microlithographic exposure process. To facilitate alignment, holding portion 100 also utilizes an inteferometer IF_{Y} 128, an inteferometer IF_{XA} 124 and an interferometer IF_{XP} 126.

Side bases 102 and center base 104 are typically a solid ceramic or other dense material providing a foundation for the balance of the equipment. The bases may be affixed to the ground or may be supported by a vibration isolation system. X-linear motor 106 and X-linear motor 108 use electromagnetic forces to move the guidebar and wafer stage along the X-axis and also rotate around the Z-axis when both X-linear motor 106 and X-linear motor 108 act in opposition. The linear motors can be air-levitation types (employing air bearings) or magnetic-levitation types (employing bearings based on the Lorentz force or a reactance force) and can move along a guide or be guideless.

Guidebar 110 provides a track for moving the wafer stage in the Y-direction also by way of linear motors. Although only guidebar 110 is illustrated in FIG. 1, multiple guidebars could be used if necessary to process multiple wafers or objects on holding portion 100. Further, even though guidebar 110 depicts only one wafer 120 being processed there could be multiple wafers processed on guidebar 110 using additional wafer chucks, wafer tables, wafer stages and linear motors (not illustrated) to independently position the wafers or objects along guidebar 110.

Wafer stage 112 supports wafer table 114, wafer chuck 118 and wafer 120 and moves in the Y-direction along guide bar 110. Selectively operating X-linear motor 106, X-linear motor 108 in conjuction with linear motors associated with guidebar 110 facilitates the positioning of wafer stage 112 in the X, Y, and θz (rotation about Z) directions. Operating the linear motors in opposition causes the θz movement.

Position information for wafer stage 112 and wafer table 114 is collected using interferometer IF_{Y} 128, interferometer IF_{XA} 124 and interferometer IF_{XP} 126. For example, interferometer IF_{Y} 128 and interferometer IF_{XA} 124 operate together to determine the position of wafer table 114 (and consequently wafer 120) in the X-direction and the Y-direction by directing their respective laser light beams at mirrors 116. Similarly, interferometer IF_{Y} 128 and interferometer IF_{XP} 126 monitor the position of wafer table 114 in the X-direction and the Y-direction respectively also by directing laser light beams at mirrors 116. Interference patterns generated by the light beams reflecting from mirrors 116 are detected and used to determine the X-direction and Y-direction position of wafer stage 112.

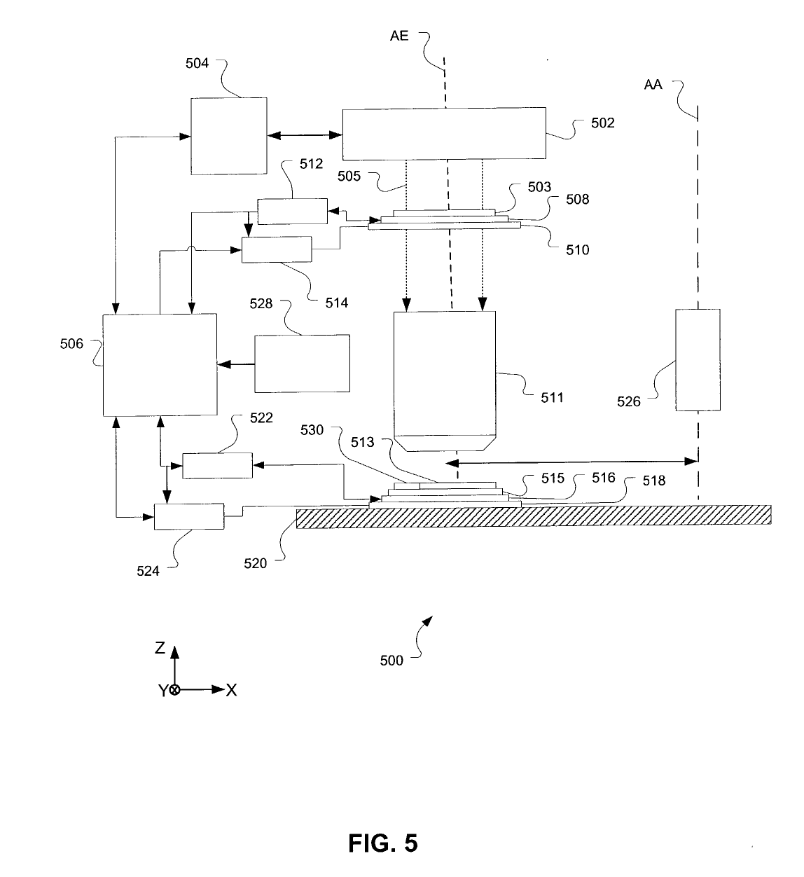

Position information gathered by the interferometers depicted in FIG. 1 facilitates aligning wafer 120 at different points in the manufacturing process. During an alignment phase of the process, holding member 100 aligns wafer 120, in part, using data from interferometer IF_{Y} 128 and interferometer IF_{XP} 126. In the alignment phase, wafer table 114 is positioned relative to an alignment axis (AA) as illustrated in FIG. 5 and is coincident with the optical axis of an alignment microscope (not illustrated). The alignment microscope focuses downward towards holding member 100 as depicted in FIG. 1 and locates fiducial mark 122 on wafer table 114 and alignment marks located on wafer 120 (alignment marks on wafer 120 not illustrated in FIG. 1) using image-processing techniques. The relative location of fiduciary mark 122 and the one or more alignment marks located on wafer 120 are compared in conjunction with position information from the interferometer devices to determine proper alignment of wafer 120. The location of the fiducial mark 122 serves as the origin of a coordinate system for measuring the position of the alignment marks on wafer 120.

A similar process is also performed during the exposure phase of the manufacturing process to ensure wafer 120 remains properly aligned. This critical step in the manufacturing process requires precisely monitoring wafer 120 and its relative position on holding member 100 as a reticle pattern is exposed on wafer 120. To reduce fabrication errors during the exposure phase, holding member 100 aligns wafer 120 again this time using interferometer IF_{Y} 128 and interferometer IF_{XP} 126 instead. During the exposure phase, wafer table 114 is positioned relative to an exposure axis AE as illustrated in FIG. 5 and is coincident with the optical axis of projection-optical system 511. In one implementation, projection-optical system 511 compares the location fiducial mark 122 on wafer table 114 with a reference mark located on a reticle 503 illustrated in FIG. 5. This operation ensures that the alignment mark locations from the wafer are properly aligned in relationship to the image being projected through reticle 503 during exposure. Typically, the position of the alignment marks associated with wafer 120 is not measured during the exposure phase.

In addition to precisely aligning wafer 120, it is also important to reduce the errors introduced by variations in the shape of wafer 120 or other substrates. Unchecked, variations in the wafer or other substrates create “wafer-induced shift” (WIS) and make it more difficult to align and expose wafer 120 with the level of accuracy required for microlithography and other precision processes. For example, wafer 120 itself or other substrates can vary in shape because a support structure below wafer 120 is uneven, does not have the requisite polished surface or does not otherwise meet the accuracy required under the circumstances.

In general, errors can be introduced if the surface of wafer 120 changes after alignment phase and before or during the exposure phase. Typical measurements made from wafer 120 during the alignment phase do not account for changes in the surface of wafer 120 during processing. These changes in the surface of wafer 120 due to environmental factors, temperature gradients and other effects make alignment mark location measurements on wafer 120 made during the alignment phase ineffective for accurately positioning the wafer subsequently during the exposure phase.

As the surface of wafer 120 changes during processing, the predetermined geometric relationship between alignment marks on wafer 120 and the reference mark on reticle 530 is also altered. Aligning fiducial mark 122 with reference mark on reticle 530 during the exposure phase does not accurately position wafer 120 as the distance between fiducial mark 122 and alignment marks on wafer 120 changes during the process. To counteract these effects, implementations of the present invention operate to reduce the amount of distortion in the surface of wafer 120 and therefore make the alignment process described above more accurate. This helps ensure proper positioning of the printed image on wafer 120 by keeping the geometric relationship between alignment marks on wafer 120, fiducial mark 122 and an alignment mark on reticle 530 undisturbed throughout the processing.

Implementations of the present invention also improve tool induced shift (TIS) measurements used to detect and correct errors introduced by the exposure system or “tool”. Use of TIS measurements is described in copending U.S. Patent application assigned to the assignee of the present invention by Michael Binnard and entitled, “Apparatus and Methods for Detecting Tool-Induced Shift In Microlithography Apparatus”, filed Aug. 3, 2001 assigned Ser. No. ______ is incorporated by reference in the entirety herein for all purposes.

TIS measurements record the location of alignment marks on wafer 120 in several positions to detect and accommodate errors due to TIS. In one implementation, a TIS measurement is made by (1) measuring the position of the alignment marks on the chips associated with wafer 120 in a first position, (2) rotating wafer 120 and wafer chuck 118 a predetermined amount, for example 180 degrees and then (3) measuring the position of the alignment marks in the second position. By taking these two measurements the TIS measurement can calculate the amount of error associated with TIS. Moreover, implementations of the present invention even make these TIS measurements and corrections more accurate than previously discovered by reducing the amount of distortion on the surface of wafer 120.

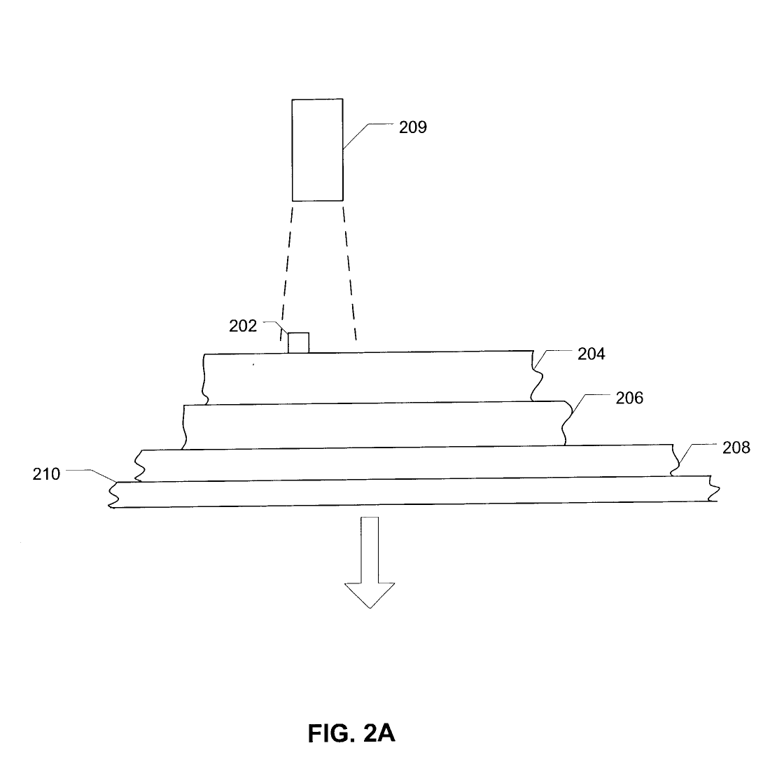

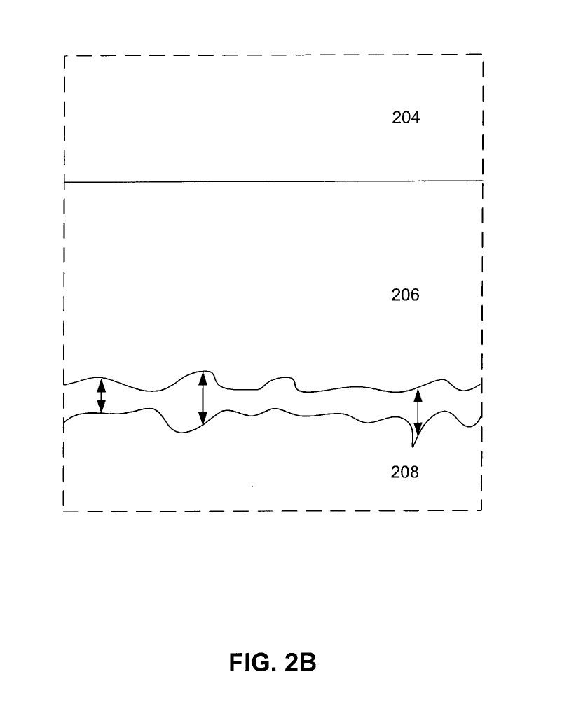

FIG. 2A provides a schematic elevation view of a wafer and the support structure below the wafer used in precision manufacturing. Elements in FIG. 2A includes a wafer 204, an alignment mark 202 on wafer 204, a holding member or wafer chuck 206, a wafer table 208 and a wafer stage 210. Beaming apparatus 209 is an apparatus that detects alignment mark 202 and other marks and may be either an exposure apparatus used to align and expose wafer 204 or an alignment microscope designed to align wafer 204 during an alignment phase. In this example, the elements depicted in FIG. 2A relate to microlithography and processing wafers but the teachings are applicable across many disciplines involving precision manufacturing. Further, one implementation of the present invention is used to make a wafer chuck for reducing distortion in a wafer during fabrication yet other types of holding members can be developed according to principles of the present invention and used to hold other types of substrates or workpieces in precision manufacturing.

Generally, beaming apparatus 209 detects alignment mark 202 positioned on the surface of wafer 204. A resist material typically covers the surface of wafer 204 and alignment mark 202. To keep wafer 204 in place, wafer 204 is affixed to wafer chuck 206 using electrostatic or vacuum forces. It is important that wafer chuck 206 keep wafer 204 in place during fabrication to obtain the highest degree of accuracy possible for measurement and exposure. Wafer table 208 supports wafer chuck 206 typically with direct contact. Both wafer table 208 and wafer stage 210 operate to move wafer chuck 206 (and wafer 204) in the X-direction, Y-direction and along other degrees of freedom as needed during processing.

In a conventional system, an uneven surface on wafer table 208 as depicted in FIG. 2B does not provide sufficiently accurate support needed for precision manufacturing. Uneven support from wafer table 208 causes the underside of wafer chuck 206 to bend and/or distort in shape. A conventional wafer chuck 206 distorts wafer 204 and reduces the ability to process wafer 204 with the high degree of precision required in microlithography. For example, distorting wafer 204 changes the position of alignment mark 202 used to precisely position wafer 204.

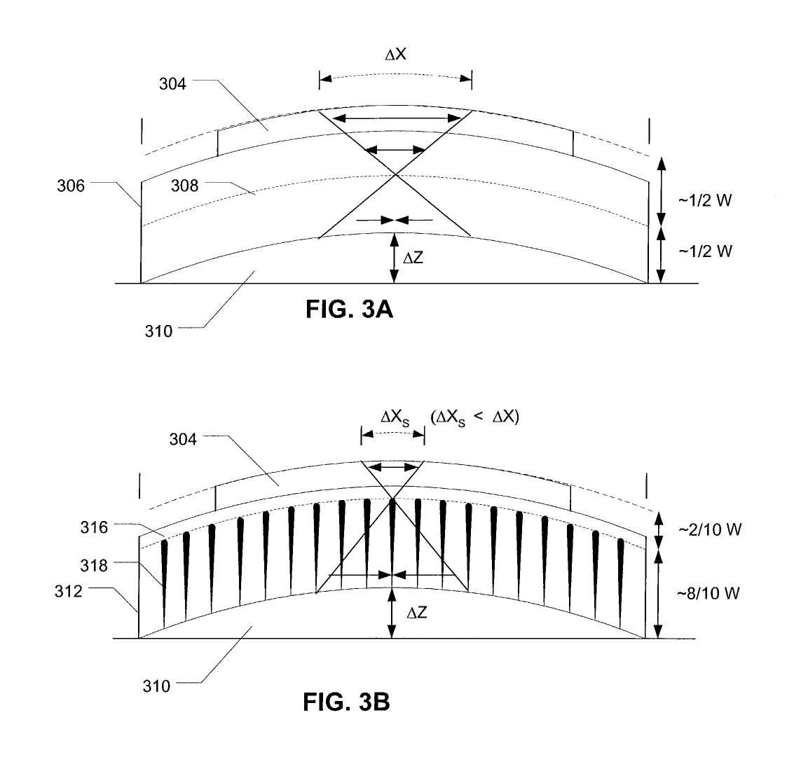

FIG. 3A is a cross-section view depicting the deformation occurring to a wafer attached to the conventional wafer chuck. Elements in this example include a wafer 304, a wafer chuck 306 having a width W with a neutral plane 308 approximately ½ W from either the top or bottom of wafer chuck 306 and a wafer table 310 supporting wafer chuck 306. In this example, neutral plane 308 describes a plane in wafer chuck 306 where the material below neutral plane 308 compresses while the material above the neutral plane 308 stretches. The strain on the upper surface of wafer chuck 306 and consequently wafer 304 is proportional to the distance between the upper surface and neutral plane 308.

Imperfections and/or deformities present on wafer table 310 displace wafer chuck 306 a distance of approximately AZ as depicted in FIG. 3A. This causes the topmost edge of wafer chuck 306 to stretch and deform wafer 304 a corresponding amount of ΔX along the X-axis. Because of the high precision required for aligning and exposing wafer 304, increasingly smaller amounts of stretching (i.e. ΔX) are acceptable. For example, an imperfection in wafer table 310 of approximately 30 nanometers (nm) and corresponding to ΔZ as depicted in FIG. 3A displaces a portion of wafer chuck 306 an approximately equal amount. The upper 10 mm of a 20 mm thick wafer chuck 306 responds by stretching and consequently deforming wafer 304 as much as 3 nm represented by ΔX in FIG. 3A. In microlithography and other precision processes, deforming a wafer or other substrate even this amount cannot be tolerated without negatively impacting yields and manufacturing requirements.

A slotted holding member depicted in FIG. 3B designed in accordance with the present invention addresses deformation of wafer 304 described above. FIG. 3B includes wafer 304, a modified wafer chuck 312 as the holding member for wafer 304 and wafer table 310 as illustrated. Wafer chuck 312 has a flat upper surface configured to attach to wafer 304 or other substrates. The lower surface of wafer chuck 312 lies parallel to the upper surface and has a number of slots 318 extending lengthwise across the lower surface and depth wise toward the upper surface of wafer chuck 312. In one implementation, the slots may extend approximately 80% of the width of wafer chuck 312 or 8/10 W where W is the width or thickness of wafer chuck 312. For example, on a wafer chuck 20 mm thick the slots would extend 16 mm into the lower surface of wafer chuck leaving approximately 4 mm material on the upper portion of wafer chuck 312. Depending on manufacturing requirements, alternate implementations may utilize a different numbers of slots oriented in different configurations and at different angles relative to the lower side of wafer chuck 312. These implementations can also use slots of different depths ranging from 10% to 90% of the thickness of wafer chuck 312 or 1/10 W to 9/10 W. Slots having a depth greater than 90% of the wafer chuck thickness (W) can also be advantageous if they can be manufactured efficiently.

Placing slots 318 in wafer chuck 312 enables the lower surface of wafer chuck 312 to flex in response variations and imperfections in the surface of a support structure such as wafer table 310. Slots 318 accommodate the imperfections along the surface of wafer table 310 or other support structure without significantly deforming wafer 304 or other substrates. Moreover, adding slots to the lower surface of wafer chuck 312 shifts the neutral plane up towards the upper surface of wafer chuck 312. Reducing the distance between the upper surface and neutral plane 316 reduces the strain on the upper surface of wafer chuck 312 and consequently the strain on wafer 304.

Wafer 304 realizes significantly less distortion using wafer chuck 312 designed in accordance with the present invention. For example, an imperfection in wafer table 310 of approximately 30 nanometers (nm) and corresponding to ΔZ as depicted in FIG. 3B displaces the lower surface of wafer chuck 312 an approximately equal amount. If the slots extend 18 mm into wafer chuck 312 then the upper surface of wafer chuck 312 is only 2 mm thick. Given the 30 nm displacement ΔZ, the upper surface of wafer chuck 312 flexes only 0.6 nm (ΔX_{S}) which is much less than 3.0 nm (ΔX) of strain generated by conventional designs. By reducing deformation in wafer 204, more accurate types of microlithography and other precision manufacturing of substrates can be accommodated.

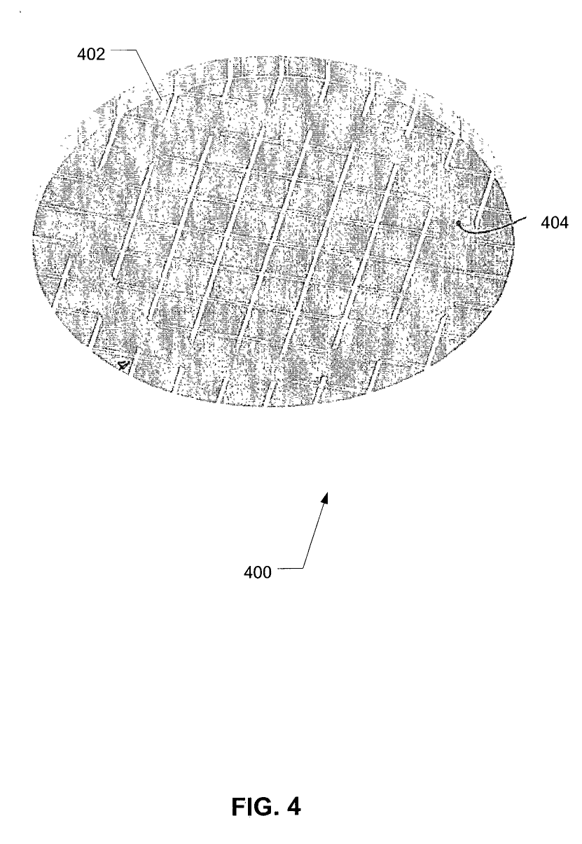

FIG. 4 provides a perspective view of a wafer chuck designed in accordance with the present invention and configured to hold a semiconductor wafer. The lower surface of wafer chuck 400 includes a number of slots 402, an annular region 404, and is configured to accommodate a round semiconductor wafer. In this implementation, slots 402 extend from the lower surface towards the upper surface at an equal depth throughout wafer chuck 400 and are arranged at right angles to each other. The depth of slots 402 can range, for example, from 1/10 W up to and including 9/10 W depending on the application and need for flexibility. Annular region 404 provides a surface for an air bearing to support wafer chuck 400 from a wafer table or other support structure below for implementations where wafer chuck 400 is rotated.

Alternate implementations, can be created having greater or fewer slots than depicted in FIG. 4 and arranged at different angles and with different depths. Further, the depths of slots 402 may vary depending on the relative position of each slot on wafer chuck 400. For example, the depth of each slot can depend on the need to make one area of wafer chuck 400 more or less flexible than another area. Selecting deep slots in wafer chuck 400 from 5/10 W to 9/10 W (e.g., 50% and 90% of the width) enables wafer chuck 400 to more effectively accommodate imperfections in the supporting surface or wafer table below and reduce deformation introduced to the wafer or substrate mounted top. Shallower depth in wafer chuck 400 provides a more rigid surface for mounting a wafer or substrate and, as a trade-off, makes wafer chuck 400 less likely to accommodate imperfections in the supporting surface or wafer table below wafer chuck 400. Given the same materials, shallower depths for the slots in wafer chuck 400 ranging from 1/10 W to 4/10 W are less flexible and capable of handling fewer imperfections in the supporting surface or wafer table while deeper slots designed in accordance with the present invention ranging from 5/10 W to 9/10 W are more likely to reduce deformation in the substrate or wafer mounted on the top surface of wafer chuck 400. Generally, the deeper slots (5/10 W to 9/10 W) are useful in reducing the likelihood of wafer deformation given an imperfect support surface or wafer table below. Shallow slot depts. (1/10 W to 4/10 W) can be used when the imperfections below are less severe and likely to introduce deformations in the wafer or substrate mounted above. On the average, the slot depth may typically range from 1/10 W to 6/10 W (10% and more than 10% to under 60%) and may increase in depth to ranges like 6/10 W to 7/10 W (60% and more than 60% to under 70%) or 7/10 W to 8/10 W (70% and more than 70% to under 80%) or 8/10 W to 9/10 W (80% and more than 80% to under 90%) to accommodate increasingly imperfect support surfaces or wafer tables supporting wafer chuck 400.

Manufacturing wafer chuck 400 is another aspect of the present invention. The upper surface of wafer chuck 400 must be smooth and flat and support wafer 304 in FIG.3 without causing wafer 304 to bend or distort. For example, finishing upper surface of wafer chuck 400 may include a variety of precision chemical and mechanical polishing and lapping methods. Because of the forces involved in polishing, it is important the wafer chuck 400 remains relatively rigid even though slots 402 have been cut into lower surface. In one implementation, slots 402 are initially cast or machined into wafer chuck 400 prior to polishing. Slots 402 are first filled with a temporary filler substance to keep wafer chuck 400 rigid during polishing and other steps in the manufacturing process. This filler substance may be a hardened temperature resistant polymer or composite material able to withstand mechanical and other forces applied during manufacturing. Once the upper surface of wafer chuck 400 is polished, the temporary filler material is removed from wafer chuck 400 and further processing of wafer chuck 400 is performed.

FIG. 5 is an elevation view illustrating a microlithographic instrument incorporating a wafer holding member in accordance with principles of the present invention. The wafer holding member previously described as a wafer chuck is also referred to as a waffle wafer chuck in view of its construction. Microlithographic instrument 500 is also referred to as a projection aligner or “stepper” as it exposes multiple areas of a wafer in a step-by-step manner. In this example, a wafer chuck 515 in FIG. 5 holds a wafer 513 while being processed by microlithographic instrument 500. Alternate implementations of the present invention, however, can be used as a holding member in various other precision manufacturing applications other than that depicted in FIG. 5 and in the foregoing description.

In operation, an illumination-optical system 502 irradiates a selected region of a reticle 503 using an illumination “light” 505. Illumination-optical system 502 is one type of an energy emission system having an exposure-light source (e.g., ultraviolet light source, extreme ultraviolet light source, charged-particle-beam source), an integrator, a variable field stop, and a condenser lens system or similar components. An image of the irradiated portion of reticle 503 is projected by a projection optical system 511 onto a corresponding region of a wafer 513 or other suitable substrate. The upstream-facing surface of the wafer 513 is coated with a suitable resist to facilitate imprinting the image on wafer 513 and projection-optical system 511 has a projection magnification P where P=¼ or ⅕, for example. An exposure controller 504 is connected to illumination-optical system 502 and operates to optimize the exposure dose on wafer 513 according to control data produced and routed to exposure controller 504 by a main control system 506.

Reticle 503 is mounted on a reticle stage 508 and positions reticle 503 relative to a reticle base 510 in the X- and Y-axis directions. In addition, reticle stage 508 also positions reticle 503 as required about the Z-axis, based on control data routed to reticle stage 508 by a reticle stage driver 514 connected to reticle stage 508. Control data produced by reticle-stage driver 514 corresponds to reticle-stage coordinates as measured by a laser interferometer 512.

Wafer 513 is mounted to a holding member such as a wafer chuck 515 designed in accordance with the present invention, which in turn is mounted on a wafer table 516. Wafer table 516 is mounted on a wafer stage 518 that moves both wafer table 516, wafer chuck 515 and wafer 513 in the X- and Y-axis directions relative to a base 520. In one implementation, wafer-stage driver 524 receives data concerning the X-Y position of wafer table 516 as measured by a laser interferometer 522. Using this positioning information enables wafer-stage driver 524 to make wafer stage 518 move stepwise in the X-axis and Y-axis directions. Each stepwise movement made by wafer stage 518 to an area of wafer 513 is followed by exposing an image of a pattern from reticle 503 onto the areas of wafer 513.

Wafer table 516 provides additional control and facilitates moving waffle wafer chuck 515 and wafer 513 in the Z-axis direction relative to projection-optical system 511. Moving wafer table 516 facilitates putting the correct distance between projection-optical system 511 and wafer 513. This movement along the Z-axis also enables wafer table 516 to operate as part of an auto-focus system that tilts wafer 513 relative to the optical axis AE and places the surface plane of wafer 513 in the proper orientation for imaging by the projection-optical system 511.

Using microlithographic instrument 500 to fabricate microelectronic devices and displays typically involve multiple microlithography steps wherein patterns from reticle 503 are superimposed onto wafer 513. For example, a first pattern may be exposed to an initial layer of a wafer while a second pattern is exposed to a subsequent layer on the same wafer overlying the initial layer. To properly expose the subsequent layer, it is important first to align reticle 503 with the proper area on wafer 513. In one implementation, microlithographic instrument 500 identifies a reference-mark member 530 on wafer table 516 to determine the position of wafer table 516. One or more reference marks on wafer 513 are used to determine the position of wafer 513. A reticle alignment microscope (not shown) aligns reticle 503 according to the position of reference-mark member 530 on wafer table 516 and reference marks on wafer 513. Further details on reference-mark member 530 and its use for alignment purposes and the like are disclosed in U.S. Pat. No. 5,243,195, and are incorporated herein by reference.

An alignment sensor 526 situated adjacent the projection-optical system 511 having an axis AA parallel to the axis AE facilitates the alignment process. In one implementation, alignment sensor 526 uses an image-pickup device to generate an image signal for alignment-signal processor 528. In turn, alignment-signal processor 528 determines the respective alignment position of wafer 513 using a number of different markings on wafer 513. The image-processing performance of alignment-signal processor 128 is disclosed in, for example, U.S. Pat. No. 5,493,403, and is incorporated herein by reference.

The apparatus depicted in FIG. S is an example microlithography system useful with one or more implementations of the present invention. Alternate implementations of the present invention can be used with a number of different types of lithographic or precision manufacturing type apparatus. For example, instead of using a stepper-type system that operates in a “step-and-repeat” manner, the microlithography system can be a scanning-type apparatus capable of exposing the pattern on reticle 503 onto wafer 513 while continuously scanning both reticle 503 and wafer 513. During such scanning, the microlithographic instrument synchronizes movement of reticle 503 and wafer 513 in opposite directions perpendicular to the optical axis AE. Scanning motions are performed by the respective reticle and wafer stages. In contrast with a scanning-type apparatus, the stepper only performs an exposure while reticle 503 and wafer 513 are stationary. For example, if an optical microlithography apparatus is used, wafer 513 typically is in a constant position relative to reticle 503 and projection-optical system 511 during exposure of a given pattern field. After the particular pattern field is exposed, wafer 513 is moved, perpendicular to the optical axis AE and relative to reticle 503, to place the next field of wafer 513 into position for exposure. In such a manner, images of the reticle pattern are sequentially exposed onto respective fields on wafer 513.

The apparatus for pattern-based exposure provided herein is not only limited to microlithography apparatus for manufacturing microelectronic devices. Alternatively, for example, the apparatus can be a liquid-crystal-device (LCD) microlithography apparatus that exposes a pattern onto a glass plate for a liquid-crystal display. In another implementation, the apparatus can be a micro lithography apparatus used for manufacturing thin-film magnetic heads. In yet another alternative, for example, the apparatus can be a proximity-microlithography apparatus used for exposing a mask pattern wherein the mask and substrate are placed in close proximity with each other, and exposure is performed without having to use a projection-optical system 511 as depicted in FIG. 5.

Alternate implementations of the invention can also be used with any of various other apparatus, including without limitation other microelectronic-processing apparatus, machine tools, metal-cutting equipment, and inspection apparatus. In any of various microlithography apparatus as described above, the energy source such as illumination light in illumination-optical system 502 can alternatively be a g-line source (438 nm), an i-line source (365 nm), a KrF excimer laser (248 nm), an ArF excimer laser (193 nm), or an F2 excimer laser (157 nm). This energy source can also be a charged particle beam such as an electron or ion beam, or a source of X-rays (including “extreme ultraviolet” radiation). If the energy source produces an electron beam, then the source can be a thermionic-emission type (e.g., lanthanum hexaboride or LaB6 or tantalum (Ta)) of electron gun. Using the electron beam, patterns can be transferred to wafer 513 from reticle 503 or directly to wafer 513 without using a reticle.

With respect to projection-optical system 511, if the illumination light comprises far-ultraviolet radiation, the constituent lenses are made of UV transmissive materials such as quartz and fluorite that readily transmit ultraviolet radiation. If the illumination light is produced by an F2 excimer laser or EUV source, then the lenses of projection-optical system 511 can be either refractive or catadioptric, and reticle 503 is reflective. If the illumination “light” is an electron beam (as a representative charged particle beam), then the projection-optical system 511 typically includes various charged-particle-beam optics such as electron lenses and deflectors, and the optical path should be in a suitable vacuum. If the illumination light is in the vacuum ultraviolet (VUV) range (less than 200 nm), then projection-optical system 511 can have a catadioptric configuration with beam splitter and concave mirror, as disclosed for example in U.S. Pat. Nos. 5,668,672 and 5,835,275, incorporated herein by reference. The projection-optical system 511 also can have a reflecting-refracting configuration including a concave mirror but not a beam splitter, as disclosed in U.S. Pat. Nos. 5,689,377 and U.S. patent application Ser. No. 08/873,606, filed on Jun. 12, 1997 incorporated herein by reference.

Either or both reticle stage 508 and wafer stage 518 can include linear motors for moving reticle 503 and wafer 513 in the X-axis and Y-axis directions respectively. The linear motors can be air-levitation types (employing air bearings) or magnetic-levitation types (employing bearings based on the Lorentz force or a reactance force). Either or both stages 508 and 518 can be configured to move along a respective guide or alternatively can be guideless. See U.S. Pat. Nos. 5,623,853 and 5,528,118, incorporated herein by reference.

Moreover, alternate implementations using reticle stage 508 or wafer stage 518 can be driven by a planar motor that drives the respective stage by electromagnetic force generated by a magnet unit having two-dimensionally arranged magnets and an armature-coil unit having two-dimensionally arranged coils in facing positions. With such a drive system, either the magnet unit or the armature-coil unit is connected to the respective stage and the other unit is mounted on a moving-plane side of the respective stage.

Movement of a reticle stage 508 and wafer stage 518 as described herein can generate reaction forces that can affect the performance of the micro lithography apparatus. Reaction forces generated by motion of wafer stage 518 can be shunted to the floor (ground) using a frame member as described, e.g., in U.S. Pat. No. 5,528,118, incorporated herein by reference. Reaction forces generated by motion of reticle stage 508 can also be shunted to the floor (ground) using a frame member as described in U.S. Pat. No. 5,874,820, incorporated herein by reference.

A microlithography apparatus such as any of the various types described can be constructed by assembling together the various subsystems, including any of the elements listed in the appended claims, in a manner ensuring that the prescribed mechanical accuracy, electrical accuracy, and optical accuracy are obtained and maintained. For example, to maintain the various accuracy specifications, before and after assembly, optical system components and assemblies are adjusted as required to achieve maximal optical accuracy. Similarly, mechanical and electrical systems are adjusted as required to achieve maximal respective accuracies. Assembling the various subsystems into a micro lithography apparatus requires the making of mechanical interfaces, electrical-circuit wiring connections, and pneumatic plumbing connections as required between the various subsystems. Typically, constituent subsystems are assembled prior to assembling the subsystems into a microlithography apparatus. After assembly of the apparatus, system adjustments are made as required to achieve overall system specifications in accuracy, etc. Assembly at the subsystem and system levels desirably is performed in a clean room where temperature and humidity are controlled.

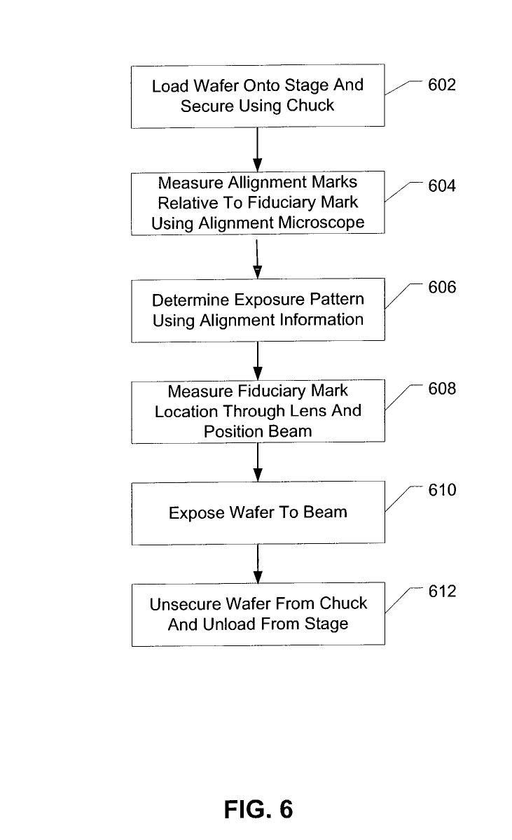

FIG. 6 provides the operations used to fabricate a wafer using a wafer chuck designed in accordance with the present invention. Initially, a wafer is loaded into exposure apparatus and secured to wafer chuck (602). For example, wafer chuck can secure wafer using either vacuum or electrostatic forces. Alignment microscope associated with microlithographic apparatus then measures alignment marks on wafer and fiduciary marks on table or stage near the wafer (604). Controllers associated with microlithographic apparatus compare the alignment marks on wafer with the fiduciary marks to determine proper alignment of wafer and change position of wafer if necessary. Alignment information is also used to determine exposure pattern for the wafer (606). For example, the exposure pattern can be adjusted to accommodate for some variations in the wafer to improve accuracy of the exposure. Wafer and supporting stages are moved into position for exposure and alignment measurements are measured again (608). This time the exposure lens rather than a separate alignment microscope determines the relative position of alignment marks and the fiduciary marks for further alignment purposes. Once aligned, the exposure apparatus exposes the wafer to a beam or other energy source to create the desired pattern on the wafer (610). Subsequently, the exposed wafer is removed from the chuck and another wafer secured to the chuck for similar processing.

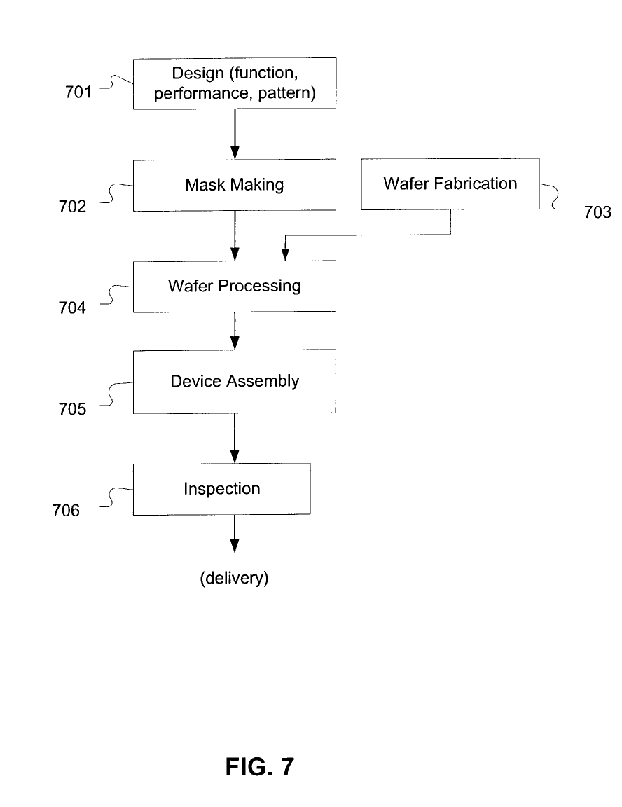

FIG. 7 depicts additional steps in a flow-chart diagram format covering the device design and delivery of the final product in addition to wafer fabrication described above using implementation of the present invention. Initially, the device's function and performance characteristics are designed (701). Next, a pattern is designed according to the previous designing step to make a mask (reticle) for creating a wafer (702). In parallel, a wafer or other suitable substrate is made (703). The mask pattern designed as described is exposed onto the wafer (704) by a photolithography system described hereinabove in accordance with the present invention. Once microlithography is complete, the semiconductor device is assembled (705) (including the dicing process, bonding process and packaging process), and then finally the device is inspected (706).

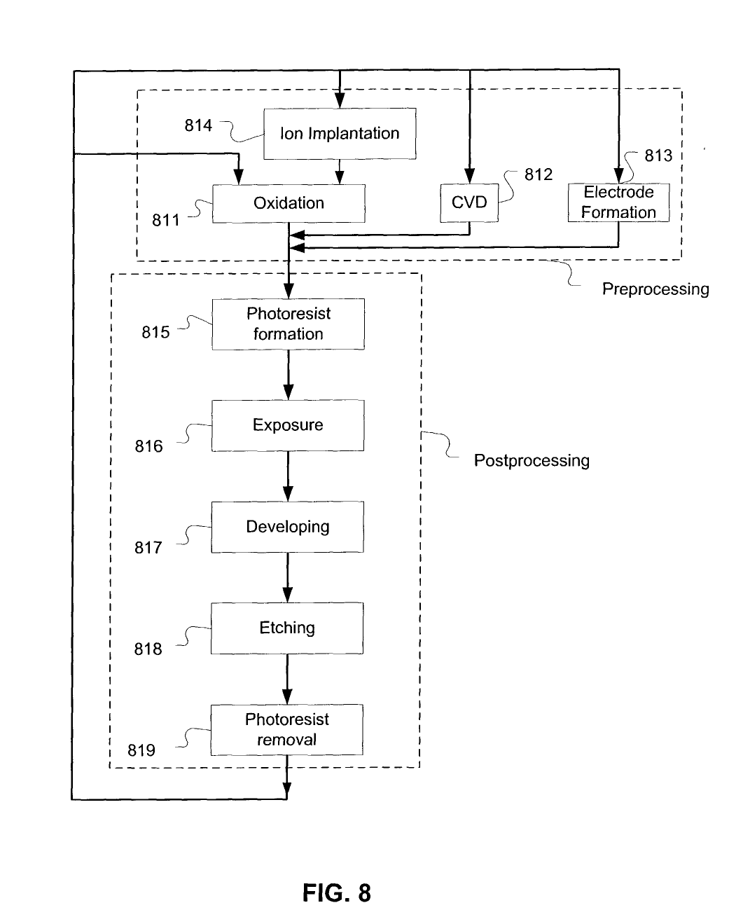

FIG. 8 illustrates a detailed flowchart example of the above-mentioned operation 704 in the case of fabricating semiconductor devices. In FIG. 8, the wafer surface is oxidized (811) and using chemical vapor deposition (CVD) an insulation film is formed on the wafer surface (812). Electrodes are formed on the wafer by vapor deposition (electrode formation) (813) and ions are implanted in the wafer (ion implantation) (814). Process elements 811-814 constitute the “preprocessing” for wafers during wafer processing; during these different operations selections are made according to processing requirements.

The following post-processing operations in the flow chart in FIG. 8 are implemented when the above-mentioned preprocessing operations have been completed. During post-processing, photoresist is applied to a wafer (photoresist formation), (815) and the above-mentioned exposure device transfers the circuit pattern of a mask (reticle) to a wafer (exposure operation) (816). Next, the exposed wafer is developed (development operation) (817) and exposed material surface other than residual photoresist is removed by etching (etching operation) (818). Lastly, unnecessary photoresist remaining after etching is removed (photoresist removal operation) (819).

Multiple circuit patterns are formed by repetition of these preprocessing and post-processing operations. It is to be understood that a photolithographic instrument may differ from the one shown herein without departing from the scope of the present invention. For example, it is to be understood that the bearings and drivers of an instrument may differ from those shown herein without departing from the scope of the present invention. It is also to be understood that the application of the present invention is not to be limited to a wafer processing apparatus. While embodiments of the present invention have been shown and described, changes and modifications to these illustrative embodiments can be made without departing from the present invention in its broader aspects, described in the appended claims.

Accordingly, the invention is not limited to the above-described implementations, but instead is defined by the appended claims in light of their full scope of equivalents.

1. An apparatus for supporting a substrate for processing during precision manufacturing, comprising:
a holding member having a flat upper surface configured to attach to the substrate; and
a lower surface parallel to the upper surface of the holding member having a number of slots extending lengthwise across the lower surface and depth wise towards the upper surface facilitating flexibility in the lower surface.

2. The apparatus in claim 1 further comprising an annular area parallel to the lower surface and covering a portion of the slots associated with the lower surface that facilitates using the holding member with precision manufacturing equipment.

3. The apparatus of claim 1 wherein the substrate is a semiconductor wafer.

4. The apparatus of claim 1 wherein the precision manufacturing includes microlithography.

5. The apparatus of claim 1 wherein the holding member is a wafer chuck.

6. The apparatus of claim 1 wherein the holding member uses electrostatic forces to secure the substrate to the upper surface of the holding member.

7. The apparatus of claim 1 wherein the holding member uses vacuum forces to secure the substrate to the upper surface of the holding member.

8. The apparatus of claim 1 wherein the holding member has a width (W) and the depth of the slots are approximately 10% and more than 10% to under 60% the width (W) of the holding member.

9. The apparatus of claim 1 wherein the holding member has a width (W) and the depth of the slots are approximately 60% and more than 60% to under 70% the width (W) of the holding member.

10. The apparatus of claim 1 wherein the holding member has a width (W) and the depth of the slots are approximately 70% and more than 70% to under 80% the width (W) of the holding member.

11. The apparatus of claim 1 wherein the holding member has a width (W) and the depth of the slots are approximately 80% and more than 80% to under 90% the width (W) of the holding member.

12. The apparatus of claim 1 wherein a portion of the slots covered by a surface parallel to the lower surface creates a bearing surface.

13. A precision manufacturing apparatus that supports a substrate during processing, comprising:
an energy emission system;
a holding member in line with the energy emission system having a flat upper surface configured to attach to the substrate and a lower surface parallel to the upper surface of the holding member having a number of slots extending lengthwise across the lower surface and depth wise towards the upper surface facilitating flexibility in the lower surface;
a substrate table that attaches to the lower surface of the holding member and configured to adjust the tilt of the holding member and facilitate focusing energy from the energy emission system; and
a stage coupled to the substrate table that facilitates movement of substrate table along one or more axes relative to the energy emission system.

14. The apparatus in claim 13 wherein the holding member further comprises an annular area parallel to the lower surface and covering a portion of the slots associated with the lower surface that facilitates using the holding member with precision manufacturing equipment.

15. The apparatus of claim 13 wherein the substrate is a semiconductor wafer.

16. The apparatus of claim 13 wherein the precision manufacturing includes microlithography.

17. The apparatus of claim 13 wherein the holding member is a wafer chuck.

18. The apparatus of claim 13 wherein the holding member uses electrostatic forces to secure the substrate to the upper surface of the holding member.

19. The apparatus of claim 13 wherein the holding member uses vacuum forces to secure the substrate to the upper surface of the holding member.

20. The apparatus of claim 13 wherein the holding member has a width (W) and the depth of the slots are approximately 10% and more than 10% to under 60% the width (W) of the holding member.

21. The apparatus of claim 13 wherein the holding member has a width (W) and the depth of the slots are approximately 60% and more than 60% to under 70% the width (W) of the holding member.

22. The apparatus of claim 13 wherein the holding member has a width (W) and the depth of the slots are approximately 70% and more than 70% to under 80% the width (W) of the holding member.

23. The apparatus of claim 13 wherein the holding member has a width (W) and the depth of the slots are approximately 80% and more than 80% to under 90% the width (W) of the holding member.

24. A method of supporting a substrate during precision manufacturing, comprising:
providing a holding member having a flat upper surface configured to attach to the substrate and a lower surface parallel to the upper surface of the holding member having a number of slots extending lengthwise across the lower surface and depth wise towards the upper surface facilitating flexibility in the lower surface;
attaching the substrate to the upper surface of the holding member;
coupling the lower surface of the holding member the surface of a substrate table; and
allowing the slots associated with the lower surface of the holding member to expand and contract in response to variations in the surface of the substrate table thereby minimizing the amount of distortion associated with the substrate attached to the upper surface of the holding member.

25. The method of claim 24, further comprises creating an annular area parallel to the lower surface and covering a portion of the slots associated with the lower surface that facilitates using the holding member with precision manufacturing equipment.

26. The method of claim 24 wherein the substrate is a semiconductor wafer.

27. The method of claim 24 wherein the precision manufacturing includes microlithography processing.

28. The method of claim 24 wherein the holding member is a wafer chuck.

29. The method of claim 24 wherein the holding member utilizes electrostatic forces to secure the substrate to the upper surface of the holding member.

30. The method of claim 24 wherein the holding member uses vacuum forces to secure the substrate to the upper surface of the holding member.

31. The method of claim 24 wherein the holding member has a width (W) and the depth of the slots are approximately 10% and more than 10% to under 60% the width (W) of the holding member.

32. The method of claim 24 wherein the holding member has a width (W) and the depth of the slots are approximately 60% and more than 60% to under 70% the width (W) of the holding member.

33. The method of claim 24 wherein the holding member has a width (W) and the depth of the slots are approximately 70% and more than 70% to under 80% the width (W) of the holding member.

34. The method of claim 23 wherein the holding member has a width (W) and the depth of the slots are approximately 80% and more than 80% to under 90% the width (W) of the holding member.

35. A method operating a precision manufacturing apparatus that supports a substrate during processing, comprising:
providing a holding member having a flat upper surface configured to attach to the substrate and a lower surface parallel to the upper surface of the holding member having a number of slots extending lengthwise across the lower surface and depth wise towards the upper surface facilitating flexibility in the lower surface;
attaching the substrate to the upper surface of the holding member;
coupling the lower surface of the holding member to the surface of a substrate table;
allowing the slots associated with the lower surface of the holding member to expand and contract in response to variations in the surface of the substrate table thereby minimizing the amount of distortion associated with the substrate attached to the upper surface of the holding member;
exposing the substrate to energy from an energy emission system;
adjusting the tilt of the holding member while focusing energy from the energy emission system onto the substrate; and
moving the substrate along one or more axes relative to the energy emission system to expose different portions of the substrate to energy from the energy emission system.

36. A method of making an object that includes the method of operating a precision manufacturing apparatus in claim 35.

37. A method of manufacturing a holding member used for supporting a substrate in precision manufacturing, comprising:
creating a holding member having an upper surface configured to attach to the substrate and a lower surface parallel to the upper surface of the holding member having a number of slots extending lengthwise across the lower surface and depth wise towards the upper surface facilitating flexibility in the lower surface;
filling the slots on the lower surface with a temporary filler material that strengthens the holding member;
precision machining the upper surface of the holding member to articulate with the substrate; and
removing the temporary material from each slot in the lower surface of the holding member once the precision machining of the upper surface is complete.

38. The method of claim 37 wherein the holding member is a wafer chuck used in microlithography.

39. The method of claim 37 wherein the filling of the slots enables the upper surface to withstand the forces associated with the precision machining.

40. The method of claim 37 wherein creating of the holding member further comprises casting the holding member using a die.

41. The method of claim 37 wherein lathes and precision machinery are used to create the holding member.

42. The method of claim 37 wherein the precision machining includes lapping the upper surface of the holding member.

43. The method of claim 37 further comprising,
placing an annular area parallel to the lower surface and covering a portion of the slots associated with the lower surface to facilitate using the holding member with precision manufacturing equipment.

44. The method of claim 37 wherein the substrate is a semiconductor wafer.

45. The method of claim 37 wherein the precision manufacturing includes microlithography.

46. The method of claim 37 wherein the holding member is a wafer chuck.

47. The method of claim 37 wherein the holding member uses electrostatic forces to secure the substrate to the upper surface of the holding member.

48. The method of claim 37 wherein the holding member uses vacuum forces to secure the substrate to the upper surface of the holding member.

49. The apparatus in claim 13 wherein the holding member further comprises a bearing surface covering a portion of the slots and parallel to the lower surface that facilitates using the holding member with precision manufacturing equipment.

50. The method in claim 24 further comprising creating a bearing surface on the holding member covering a portion of the slots and parallel to the lower surface that facilitates using the holding member with precision manufacturing equipment.

51. The method in claim 35 wherein the holding member further comprises a bearing surface covering a portion of the slots and parallel to the lower surface that facilitates using the holding member with precision manufacturing equipment.

52. The method in claim 37 further comprising creating a bearing surface on the holding member covering a portion of the slots and parallel to the lower surface that facilitates using the holding member with precision manufacturing equipment.
